(19) United States
(12) Patent Application Publication
(10) Pub. No.: US 2026/0039555 A1
(43) Pub. Date: Feb. 5, 2026

(54) METHODS, SYSTEMS, AND COMPUTER READABLE MEDIA FOR INCREASING RESILIENCE OF NETWORK TOPOLOGY HIDING ACROSS GEO-REDUNDANT SECURITY EDGE PROTECTION PROXIES (SEPPs)

(71) Applicant: Oracle International Corporation, Redwood Shores, CA (US)

(72) Inventors: Sonia Kadyan, New Delhi (IN); Jay Rajput, Bangalore (IN); Jon Nirmal Mohan Raj, Bangalore (IN); Ashis Jyoti Sharma, New Delhi (IN)

(21) Appl. No.: 18/789,433

(22) Filed: Jul. 30, 2024

(51) Int. Cl. H04L 41/12; H04W 12/63; H04W 84/04

(52) U.S. Cl. CPC H04L 41/12; H04W 12/63; H04W 84/042

(57) ABSTRACT

A method for increasing resilience of network topology hiding across geo-redundant SEPPs includes subscribing, with an NRF to receive notification of network topology updates of producer NFs configured to send inter-PLMN messages. The method includes receiving a notification including updated network topology information regarding one of the producer NFs. The method further includes generating, based on the updated network topology information, updated network topology hiding information for the producer NF. The method further includes receiving an inter-PLMN SBI request message requiring network topology recovery. The method further includes performing, using the updated network topology hiding information, the network topology recovery and forwarding the inter-PLMN SBI request message to the producer NF.

### TECHNICAL FIELD

The subject matter described herein relates to managing network topology hiding in communications networks. More particularly, the subject matter described herein relates to methods, systems, and computer readable media for increasing resilience of network topology hiding across geo-redundant SEPPs.

### BACKGROUND

In 5G telecommunications networks, a network function that provides service is referred to as a producer network function (NF) or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF instance is an instance of a producer NF that provides one or more services. A given producer NF may include more than one NF instance. It should also be noted that multiple NF instances can share the same service endpoint.

NFs register with an NF repository function (NRF). The NRF maintains profiles of available NF instances identifying the services supported by each NF instance. The profile of an NF instance is referred to in 3GPP TS 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the types of services provided by an NF instance as well as contact and capacity information regarding the NF instance.

SCPs route messages between producer NF instances. An SCP can also invoke the NF discovery service operation to learn about available producer NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instance.

One problem that can occur in 5G, previous generation, and subsequent generation networks is that network topology hiding information may not be shared across geo-redundant nodes, which may result in routing failures. For example, in 5G networks, the SEPP performs network topology hiding by replacing NF identifiers, such as fully qualified domain names (FQDNs), in outbound inter-public land mobile network (PLMN) service-based interface (SBI) request messages with pseudo-identifiers. If an NF updates its network topology information, and the update is not communicated to all of the SEPPs in a geo-redundant SEPP deployment, the SEPPs without the updated network topology information will not be able to route messages that contain pseudo-identifiers based on the updated network topology information.

Accordingly, in light of these and other difficulties, there exists a need for improved methods, systems and computer readable media for increasing the resilience of network topology hiding across geo-redundant SEPPs.

### SUMMARY

A method for increasing resilience of network topology hiding across geo-redundant security edge protection proxies (SEPPs) includes subscribing, by a SEPP of a plurality of geo-redundant SEPPs and with a network function (NF) repository function (NRF), to receive notification of network topology updates of producer NFs configured to send inter-public land mobile network (PLMN) messages. The method further includes receiving, by the SEPP and from the NRF, a notification including updated network topology information regarding one of the producer NFs. The method further includes generating, by the SEPP and based on the updated network topology information, updated network topology hiding information for the producer NF. The method further includes receiving, by the SEPP, an inter-PLMN service-based-interface (SBI) request message requiring network topology recovery. The method further includes performing, by the SEPP and using the updated network topology hiding information, the network topology recovery. The method further includes forwarding the inter-PLMN SBI request message to the producer NF.

According to another aspect of the subject matter described herein, subscribing with the NRF comprises sending an NF status subscribe message to the NRF.

According to another aspect of the subject matter described herein, subscribing with the NRF comprises subscribing with a central NRF of a plurality of NRFs.

According to another aspect of the subject matter described herein, receiving the notification includes receiving an NF status notify request message.

According to another aspect of the subject matter described herein, receiving the notification includes receiving an updated fully qualified domain name (FQDN) of the producer NF that is different from a previous FQDN of the producer NF that was registered with the NRF.

According to another aspect of the subject matter described herein, generating the updated network topology hiding information includes generating an updated pseudo-FQDN for the producer NF that is different from a pseudo-FQDN mapped to the previous FQDN of the producer NF that was registered with the NRF and storing a mapping between the updated pseudo-FQDN and the updated FQDN.

According to another aspect of the subject matter described herein, receiving the inter-PLMN SBI request message requiring network topology recovery includes receiving an inter-PLMN SBI request message addressed to the updated pseudo-FQDN of the producer NF.

According to another aspect of the subject matter described herein, performing the network topology recovery includes accessing the stored mapping between the updated pseudo-FQDN and the updated FQDN and replacing the updated pseudo-FQDN with the updated FQDN.

According to another aspect of the subject matter described herein, replacing the updated pseudo-FQDN with the updated FQDN includes replacing the updated pseudo-FQDN in a 3gpp-Sbi-Target-apiRoot header of the inter-PLMN SBI request message.

According to another aspect of the subject matter described herein, the method for increasing the resilience of network topology hiding across geo-redundant SEPPs includes confirming, by the SEPP and prior to performing network topology hiding using the updated network topology information, that the updated network topology information is available at the geo-redundant SEPPs.

According to another aspect of the subject matter described herein, a system for increasing resilience of network topology hiding across geo-redundant security edge protection proxies (SEPPs) is provided. The system includes a SEPP including at least one processor and a memory. The system further includes a network topology manager implemented by the at least one processor for subscribing with a network function (NF) repository function (NRF), to receive notification of network topology updates of producer NFs configured to send inter-public land mobile network (PLMN) messages, receiving, from the NRF, a notification including updated network topology information regarding one of the producer NFs, generating, based on the updated network topology information, updated network topology hiding information for the producer NF, receiving an inter-PLMN service-based-interface (SBI) request message requiring network topology recovery, performing, using the updated network topology hiding information, the network topology recovery. The system further includes a routing manager implemented by the at least one processor for forwarding the inter-PLMN SBI request message to the producer NF.

According to another aspect of the subject matter described herein, the network topology manager is configured to subscribe with the NRF by sending an NF status subscribe message to the NRF.

According to another aspect of the subject matter described herein, the NRF comprises a central NRF of a plurality of NRFs.

According to another aspect of the subject matter described herein, the notification comprises an NF status notify request message.

According to another aspect of the subject matter described herein, the notification includes an updated fully qualified domain name (FQDN) of the producer NF that is different from a previous FQDN of the producer NF that was registered with the NRF.

According to another aspect of the subject matter described herein, the network topology manager is configured to generate the updated network topology hiding information by generating an updated pseudo-FQDN for the producer NF that is different from a pseudo-FQDN mapped to the previous FQDN of the producer NF that was registered with the NRF and the network topology manager is configured to store a mapping between the updated pseudo-FQDN and the updated FQDN.

According to another aspect of the subject matter described herein, the inter-PLMN SBI request message requiring network topology recovery includes an inter-PLMN SBI request message addressed to the updated pseudo-FQDN of the producer NF.

According to another aspect of the subject matter described herein, the network topology manager is configured to perform the network topology recovery by accessing the stored mapping between the updated pseudo-FQDN and the updated FQDN and replacing the updated pseudo-FQDN with the updated FQDN in a 3gpp-Sbi-Target-apiRoot header of the inter-PLMN SBI request message.

According to another aspect of the subject matter described herein, the network topology manager is configured to confirm, prior to performing network topology hiding using the updated network topology information, that the updated network topology information is available at the geo-redundant SEPPs.

According to another aspect of the subject matter described herein, a non-transitory computer readable medium having stored thereon executable instructions that when executed by a processor of a computer control the computer to perform steps is provided. The steps include subscribing, by a security edge protection proxy (SEPP) of a plurality of geo-redundant SEPPs and with a network function (NF) repository function (NRF), to receive notification of network topology updates of producer NFs configured to send inter-public land mobile network (PLMN) messages. The steps further include receiving, by the SEPP and from the NRF, a notification including updated network topology information regarding one of the producer NFs. The steps further include generating, by the SEPP and based on the updated network topology information, updated network topology hiding information for the producer NF. The steps further include receiving, by the SEPP, an inter-PLMN service-based-interface (SBI) request message requiring network topology recovery. The steps further include performing, by the SEPP and using the updated network topology hiding information, the network topology recovery. The steps further include forwarding the inter-PLMN SBI request message to the producer NF.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which: FIG. 1 is a network diagram illustrating an exemplary 5G system network architecture;

FIG. 2 is a network diagram illustrating geo-redundantly deployed SEPPs and a problem that can occur when network topology hiding information is not available across the SEPPs;

FIG. 3 is a network diagram illustrating proactive updating of network topology information among mated SEPPs;

FIG. 4 is a message flow diagram illustrating messages exchanged among geo-redundant SEPPs in proactively updating network topology information and using the network topology information for network topology hiding and recovery;

FIG. 5 is a block diagram illustrating an exemplary architecture for a SEPP configured to proactively obtain network topology information, share the network topology information, and generate and use corresponding network topology hiding information; and

FIG. 6 is a flow chart illustrating an exemplary process for increasing resilience of network topology hiding across geo-redundant SEPPs.

### DETAILED DESCRIPTION

FIG. 1 is a network diagram illustrating an exemplary 5G system network architecture. The architecture in FIG. 1 includes NRF 100 and SCP 101, which may be located in the same home public land mobile network (HPLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the types of services provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include a policy control function (PCF) 102 that performs policy related operations in a network, a unified data management function (UDM) 104 that manages user data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 provides authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (IoT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNB (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

A SEPP 126 filters incoming traffic from another PLMN and can perform topology hiding for traffic exiting the home PLMN. SEPP 126 may communicate with a SEPP in a foreign PLMN which manages security for the foreign PLMN. Thus, traffic between NFs in different PLMNs may traverse two SEPP functions, one for the home PLMN and the other for the foreign PLMN. A SEPP filtering egress messages from consumer NFs in a PLMN is referred to as a consumer SEPP or C-SEPP. A SEPP that filters ingress messages directed to producer NFs in a PLMN is referred to as a producer SEPP or P-SEPP. A given SEPP can function as a C-SEPP and a P-SEPP, depending on the role the SEPP is performing.

A unified data repository (UDR) 128 stores subscription data for UEs. A binding support function (BSF) 130 manages bindings between PDU sessions and PCFs.

As stated above, one problem with 5G, previous generation, and subsequent generation networks is that network topology hiding information may not be made available in a timely manner to geo-redundantly deployed network nodes, such as SEPPs, which can cause routing failures. Geo-redundant SEPPs require network topology hiding information to be shared for high availability, i.e., in case of a SEPP failure, mate SEPPs should be able to use the shared network topology hiding information to perform network topology recovery. Such topology hiding information when shared reactively using asynchronous mechanisms, such as database replication or similar technologies, is impacted by the delay introduced by such asynchronous mechanisms. Synchronous sharing of topology hiding information solves the problems with the asynchronous mechanism but introduces delay in the message processing and so is not considered an option.

The subject matter described herein includes configuring the SEPPs to use the NRF to monitor the topology of NFs in the home network. The SEPP will create an encrypted mapping between the topology information retrieved from the NRF and topology hiding information. This mapping will be shared across other SEPPs. SEPPs will use this information to perform NF topology recovery and forward messages after an indication that all the mated pairs have the same information.

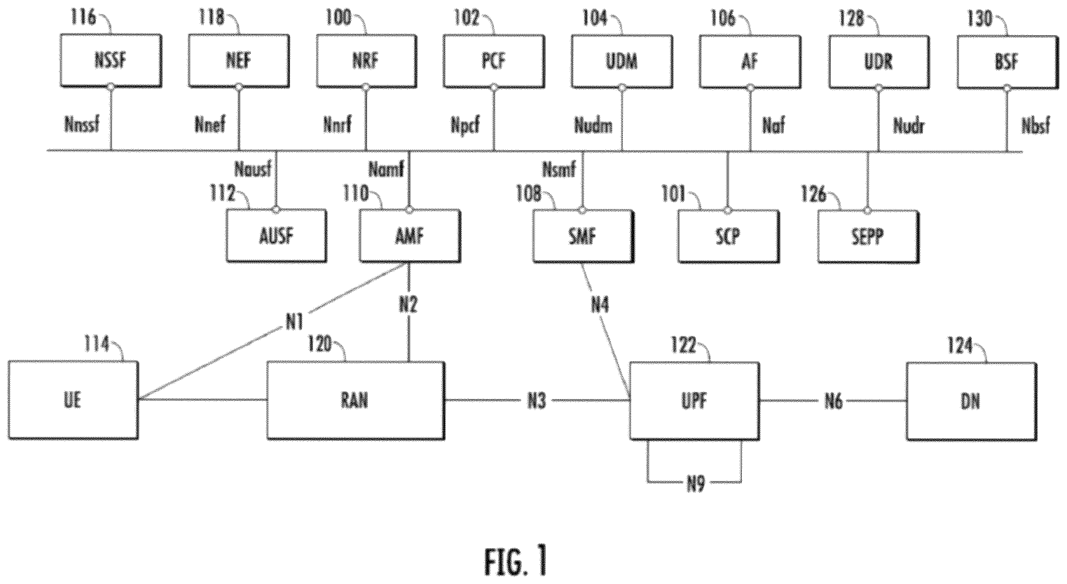

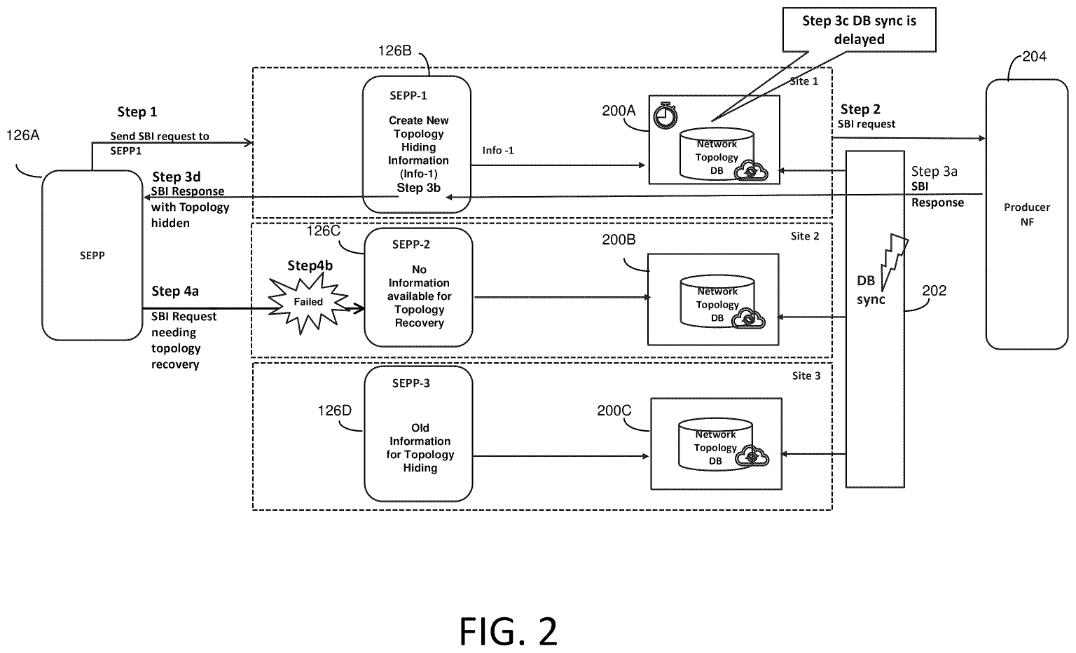

FIG. 2 is a network diagram illustrating geo-redundantly deployed SEPPs and a problem that can occur when network topology hiding information is not available across the SEPPs. Referring to FIG. 2, a SEPP 126A may communicate inter-PLMN SBI request messages to geo-redundantly deployed SEPPs 126B, 126C, and 126D. SEPPs 126B, 126C, and 126D maintain network topology databases 200A, 200B, and 200C, respectively. The network topology databases are synchronized by a database synchronization process 202.

Referring to the message flow in FIG. 2, in step 1, SEPP 126A sends an SBI request message to SEPP 126B. In step 2, SEPP 126B routes the SBI request message to producer NF 204. In step 3a, producer NF 204 generates and sends an SBI response message to the consumer NF that originated the SBI request message in step 1. In step 3b, SEPP 126B receives the SBI response message and performs network topology hiding to hide the identifier of producer NF 204 in the SBI response message. In step 3c, the database synchronization process of updating network topology databases 200B and 200C is delayed, for example, due to a network failure or network congestion. It is important to note that the network topology hiding is performed based on the updated network topology information of producer NF 204 that is made available to SEPP 126B in the SBI response message. However, the updated network topology information and the corresponding updated network topology hiding information is not available to SEPPs 126C and 126D, for example, due to the database synchronization failure. In step 3d, SEPP 126B forwards the SBI response message to SEPP 126A, which forwards the SBI response message to the consumer NF.

The consumer NF receives the SBI response message, generates a new SBI request message, and sends the SBI request message to SEPP 126A. In step 4a, SEPP 126A sends the SBI request message to SEPP 126C. The reason that SEPP 126A sends the SBI request message to SEPP 126C instead of SEPP 126B is that SEPP 126B may be experiencing a failure condition. The SBI request message may also be sent to SEPP 126C instead of SEPP 126B for load balancing purposes. The SBI request message needs NF topology recovery, i.e., the SBI request message is addressed to the pseudo-identifier of producer NF 204, and the pseudo-identifier needs to be replaced with the real identifier of producer NF 204 before forwarding the SBI request message to producer NF 204. However, because SEPP 126C lacks the updated network topology hiding information for producer NF 204, SEPP 126C is unable to perform the NF topology recovery and, in step 4b, routing of the inter PLMN SBI request message fails.

Table 1 shown below illustrates topology hiding information generated by SEPP 126B for producer NF 204, where producer NF 204 is assumed to be an AUSF with the FQDN of 5gc.ausf1.mnc987.mcc654.3gppnetwork.org.

TABLE 1
Network Topology Hiding Information
Prior to Network Topology Update

| | | 3GPP | | |
|---|---|---|---|---|
| | AUSF FQDN | Msg. | Real | Pseudo- |
| SEPP | in NF Profile | Param. | Identifier | identifier |
| SEPP | 5gc.ausf1.mn | 3gpp- | 5gc.ausf1.mnc9 | 5gc.psuedo1.mnc9 |
| 126B | c987.mcc654. | Sbi- | 87.mcc654.3gpp | 87.mcc654.3gppne |
| | 3gppnetwork. | Target- | network.org | twork.org |
| | org | apiRoot | | |
| SEPP | 5gc.ausf1.mn | 3gpp- | 5gc.ausf1.mnc9 | 5gc.pseudo1.mnc9 |
| 126C | c987.mcc654. | Sbi- | 87.mcc654.3gpp | 87.mcc654.3gppne |
| | 3gppnetwork. | Target- | network.org | twork.org |
| | org | apiRoot | | |
| SEPP | 5gc.ausf1.mn | 3gpp- | 5gc.ausf1.mnc9 | 5gc.pseudo1.mnc9 |
| 126D | c987.mcc654. | Sbi- | 87.mcc654.3gpp | 87.mcc654.3gppne |
| | 3gppnetwork. | Target- | network.org | twork.org |
| | org | apiRoot | | |

As shown in Table 1, SEPP 126B generated the pseudo-identifier 5gc.psuedo1.mnc987.mcc654.3gppnetwork.org for producer NF 204 and has either replicated the pseudo-identifier to SEPPs 126C and 126D or the network topology information to SEPPs 126C and 126D, allowing SEPPs 126C and 126D to generate their own network topology hiding information using the same algorithm as SEPP 126B, resulting in consistent network topology hiding information across SEPPs 126B, 126C, and 126D. The data in Table 1 assumes that an NF topology update for producer NF 204 has not yet occurred. When any of SEPPs 126B, 126C, and 126D receives an SBI request with the 3gpp-Sbi-Target-apiRoot parameter equal to 5gc.psuedo1.mnc987.mcc654.3gppnetwork.org, the receiving SEPP will perform network topology recovery by replacing the pseudo-identifier with the real identifier of 5gc.ausf1.mnc987.mcc654.3gppnetwork.org for producer NF 204 and forward the SBI request to producer NF 204. Similarly, for outbound inter-PLMN messages that contain the real identifier of 5gc.ausf1.mnc987.mcc654.3gppnetwork.org for producer NF 204, SEPPs 126B, 126C, and 126D will perform network topology hiding by replacing the real identifier for producer NF 204 with the pseudo-identifier.

When producer NF 204 updates its NF identifier, producer NF 204 registers its updated identifier with the NRF. SEPP 126B becomes aware of the updated identifier, e.g., by receiving an SBI response from producer NF 204 with the updated identifier, and creates new topology hiding information, However, due to a database synchronization failure, the updated network topology information and the corresponding network topology hiding information is not available to SEPPs 126C and 126D. Table 2 shown below illustrates the status of the network topology databases of SEPPs 126B, 126C, and 126D after a network topology update of the identify of producer NF 204 with SEPP 126B and a failed network topology update at SEPPs 126C and 126D.

TABLE 2
Network Topology Hiding Information after Network Topology
Update at SEPP 126B but not SEPPs 126C and 126D

| | | 3GPP | | |
|---|---|---|---|---|
| | AUSF FQDN | Msg. | Real | Pseudo- |
| SEPP | in NF Profile | Param. | Identifier | identifier |
| SEPP | 5gc.ausf5.mn | 3gpp- | 5gc.ausf5.mnc9 | 5gc.psuedo8.mnc9 |
| 126B | c987.mcc654. | Sbi- | 87.mcc654.3gpp | 87.mcc654.3gppne |
| | 3gppnetwork. | Target- | network.org | twork.org |
| | org | apiRoot | | |
| SEPP | 5gc.ausf1.mn | 3gpp- | 5gc.ausf1.mnc9 | 5gc.pseudo1.mnc9 |
| 126C | c987.mcc654. | Sbi- | 87.mcc654.3gpp | 87.mcc654.3gppne |
| | 3gppnetwork. | Target- | network.org | twork.org |
| | org | apiRoot | | |
| SEPP | 5gc.ausf1.mn | 3gpp- | 5gc.ausf1.mnc9 | 5gc.pseudo1.mnc9 |
| 126D | c987.mcc654. | Sbi- | 87.mcc654.3gpp | 87.mcc654.3gppne |
| | 3gppnetwork. | Target- | network.org | twork.org |
| | org | apiRoot | | |

In Table 2, only SEPP 126B has the updated network topology information 5gc.ausf5.mnc987.mcc654.3gppnetwork.org and network topology hiding information 5gc.pseudo8.mnc987.mcc654.3gppnetwork.org for producer NF 204. As a result, when one of SEPPs 126C and 126D receives a message addressed to 5gc.pseudo8.mnc987.mcc654.3gppnetwork.org, SEPPs 126C and 126D will be unable to perform network topology recovery for the message, and routing of the message will fail.

To reduce the likelihood of routing failures caused by unavailability of network topology hiding information at geo-redundant SEPPs, the subject matter described herein includes a solution to proactively, rather than reactively, share network topology information across geo-redundant SEPPs.

Proactively sharing the network topology information makes geo-redundant SEPPs more resilient to failure than the reactive sharing described above with respect to FIG. 2. In one example, geo-redundant SEPPs subscribe with the NRF to receive network topology updates regarding NFs that can send inter-PLMN SBI messages (e.g., AMFs, AUSFs, SMFs, UDMs, etc.). The NRF will notify the geo-redundant SEPPs when any of the NFs changes its network topology. On notification from the NRF of a topology change, all SEPPs will process the notification to generate network topology information, such as that illustrated in Table 1, for the new FQDN of the NF. The SEPPs also generate network topology hiding information that maps the FQDN to the pseudo-identifier. The network topology hiding information is used by the SEPPs to perform network topology hiding and recovery to convert between actual and pseudo-identifiers, provided the network topology information individually created by a SEPP is available to the mate SEPPs.

Without this solution, the network topology information was generated at run time during SBI signalling processing. Database replication was then used to share the network topology information with mate SEPPs. When a database replication failure occurred, mate SEPPs did not have the network topology information and could not perform the topology recovery for the topology hiding performed by the SEPP that obtained the network topology information at run time.

As part of the solution described herein, SEPPs that receive a topology update from the NRF and generate new network topology information from the update and may check that the network topology information generated by receiving SEPP is available to the mated SEPPs. On confirmation of availability of network topology information by all mated SEPPs in a geo-redundant SEPP deployment, the SEPP that generated the network topology information may use the network topology information for network topology hiding. In absence of confirmation of availability of the network topology information on all SEPPs, a network topology hiding operation may be marked as failed.

Because network topology information is shared as soon as the notification of a topology change or update is received from NRF, the likelihood of receiving SBI signalling for an NF for which the network topology information is not available at all the SEPPs is low. The generated network topology information for an NF is refreshed periodically and shared with mated SEPPs. A SEPP may use the older shared information but not the newer information unless and until receipt of the newer information is confirmed by the mated SEPP. Once the newer network topology information is shared, the older information may not be used for topology hiding but can be used for topology recovery for a configurable amount of time. For example, if a SEPP receives an SBI request message with a previous pseudo-identifier for a NF, the SEPP may replace the pseudo-identifier with the real identifier for the NF using the previous network topology hiding information.

If a set of geo-redundant SEPPs is initially configured with network topology information as illustrated in Table 1, producer NF 204 updates its network topology information the NRF, and the NRF sends notification of a network topology update to SEPP 126B, SEPP 126B will communicate the updated network topology information to SEPPs 126C and 126D using the database replication process. Table 3 shown below illustrates the network topology information at SEPPs 126B, 126C, and 126D after a network topology update by producer NF 204 and replication to SEPPs 126C and 126D.

TABLE 3
Network Topology information at SEPPs after Network
Topology Update and Database Replication

| | | 3GPP | | |
|---|---|---|---|---|
| | AUSF FQDN | Msg. | Real | Pseudo- |
| SEPP | in NF Profile | Param. | Identifier | identifier |
| SEPP | 5gc.ausf5.mn | 3gpp- | 5gc.ausf5.mnc9 | 5gc.psuedo8.mnc9 |
| 126B | c987.mcc654. | Sbi- | 87.mcc654.3gpp | 87.mcc654.3gppne |
| | 3gppnetwork. | Target- | network.org | twork.org |
| | org | apiRoot | | |
| SEPP | 5gc.ausf5.mn | 3gpp- | 5gc.ausf5.mnc9 | 5gc.pseudo8.mnc9 |
| 126C | c987.mcc654. | Sbi- | 87.mcc654.3gpp | 87.mcc654.3gppne |
| | 3gppnetwork. | Target- | network.org | twork.org |
| | org | apiRoot | | |
| SEPP | 5gc.ausf5.mn | 3gpp- | 5gc.ausf5.mnc9 | 5gc.pseudo8.mnc9 |
| 126D | c987.mcc654. | Sbi- | 87.mcc654.3gpp | 87.mcc654.3gppne |
| | 3gppnetwork. | Target- | network.org | twork.org |
| | org | apiRoot | | |

As indicated in Table 3, the new FQDN for the AUSF is 5gc.ausf5.mnc987.mcc654.3gppnetwork.org, the new pseudo-identifier for the AUSF is 5gc.psuedo8.mnc987.mcc654.3gppnetwork.org, and the updated mapping is available at all of the SEPPs for network topology hiding and recovery.

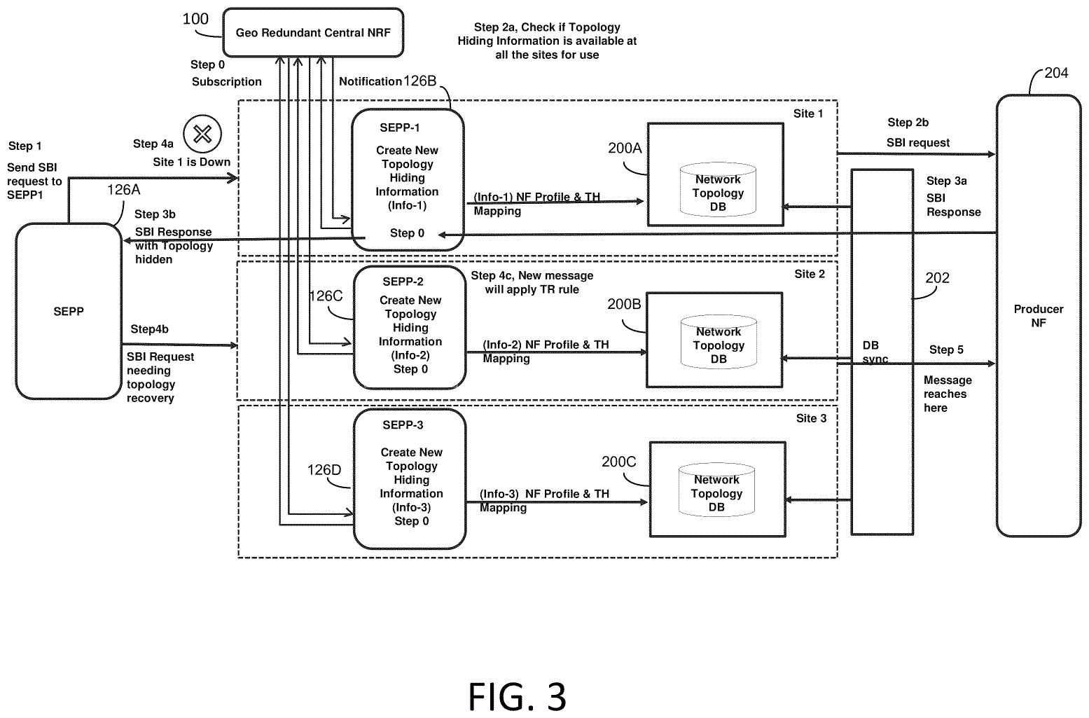

FIG. 3 is a network diagram illustrating proactive updating of network topology information among mated SEPPs. Referring to FIG. 3, in step 0, SEPPs 126B, 126C, and 126D subscribe with NRF 100 to receive updates in network topology regarding producer NF 204, receive notification of an update in the network topology, and update their respective network topology databases 200A, 200B, and 200C. In step 1, SEPP 126A sends an SBI request to SEPP 126B. In step 2a, SEPP 126B checks to see if the network topology hiding information has been updated with SEPPs 126C and 126D. In step 2b, SEPP 126B forwards the SBI request to producer NF 204. In step 3a, producer NF 204 sends an SBI response to SEPP 126B. SEPP 126B performs network topology hiding by replacing the real identifier of producer NF 204 with the pseudo-identifier and, in step 3b, forwards the SBI response to SEPP 126A.

In step 4a, SEPP 126B goes down. In step 4b, SEPP 126A sends an SBI request needing network topology recovery to SEPP 126C. SEPP 126C receives the SBI request and, in step 4c performs network topology recovery using the updated network topology information. Performing the network topology recovery may include replacing the pseudo-identifier of producer NF 204 with the real identifier of producer NF 204. After performing the network topology recovery, in step 5, SEPP 126C forwards the message to producer NF 204.

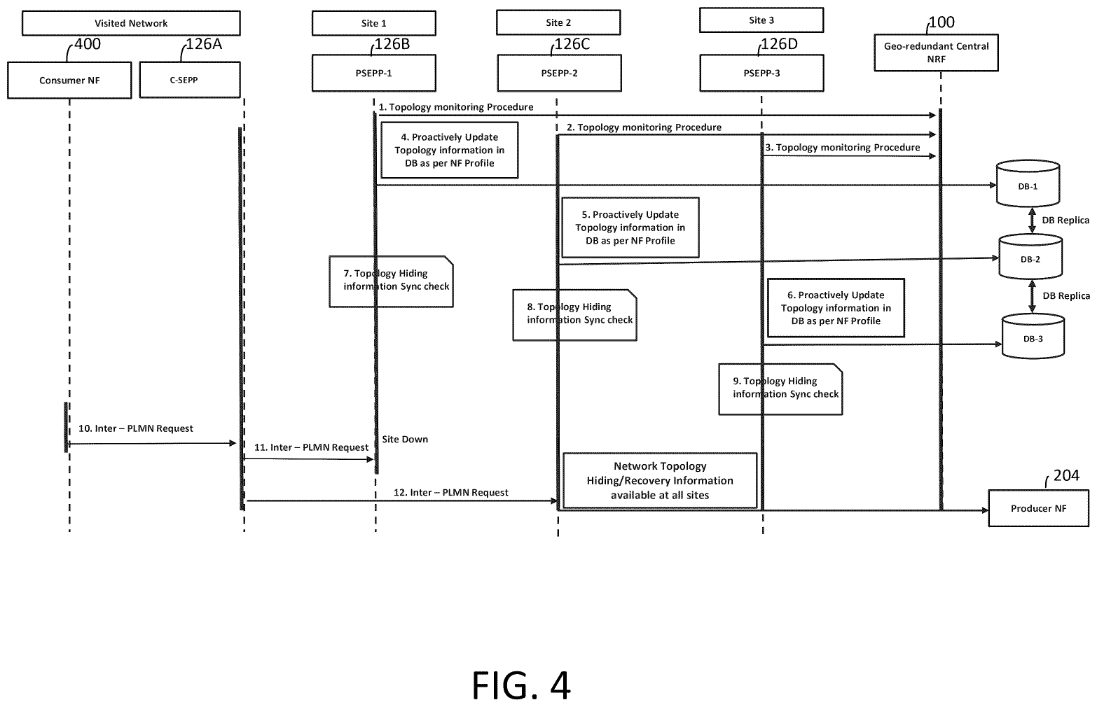

FIG. 4 is a message flow diagram illustrating messages exchanged among geo-redundant SEPPs in proactively updating network topology information and using the network topology information for network topology hiding and recovery. Referring to FIG. 4, in steps 1-3, geo-redundant SEPPs 126B, 126C, and 126D subscribe with NRF 100 for network topology updates regarding producer NF 204 and receive notification of a network topology update. In steps 4-6, SEPPs 126B, 126C, and 126D update their respective network topology databases 200A, 200B, and 200C with the updated network topology information and the updated network topology hiding information. In steps 7-9, SEPPs 126B, 126C, and 126D check with each other to make sure that the updated network topology hiding information is available at all of the SEPPs 126B, 126C, and 126D. In step 10, a consumer NF 400 generates and sends an SBI request to C-SEPP 126A. In step 11, C-SEPP 126A forwards the SBI request to P-SEPP 126B. However, P-SEPP 126B is out of service or unreachable. Accordingly, in step 12, C-SEPP 126A reattempts the SBI request by sending the SBI request to SEPP 126C. Because the SBI request includes a pseudo-identifier for producer NF 204. Because SEPP 126C has the updated network topology hiding information for producer NF 204, SEPP 126C performs network topology recovery by replacing the pseudo-identifier for producer NF 204 in the 3gpp-Sbi-Target-apiRoot header of the SBI request message with the real identifier for producer NF 204. In step 13, SEPP 126C forwards the SBI request to producer NF 204.

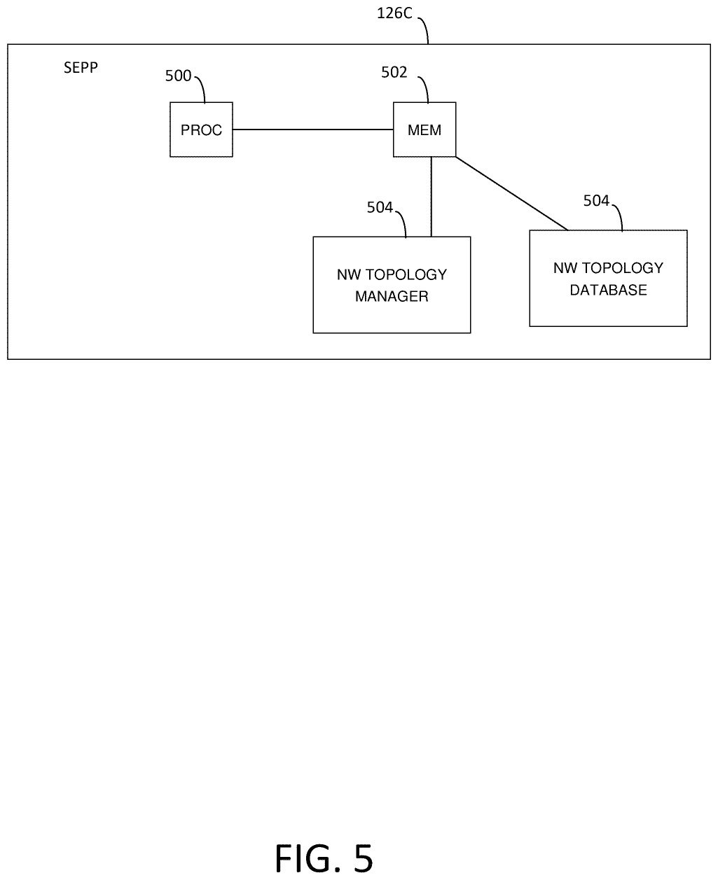

FIG. 5 is a block diagram illustrating an exemplary architecture for a SEPP configured to proactively obtain network topology information, share the network topology information, and generate and use corresponding network topology hiding information. Referring to FIG. 5, SEPP 126C includes at least one processor 500 and memory 502. SEPP 126C also includes network topology database 200B in which SEPP 126C stores network topology information and corresponding network topology hiding information. An example of the type of network topology and network topology hiding information that may be stored in network topology database 200B is illustrated above in Table 3.

SEPP 126C also includes a network topology manager 504 that proactively obtains the network topology information from the NRF, stores the information in network topology database 200B, generates the network topology hiding information, and uses the network topology hiding information for network topology hiding and recovery. Using the network topology information for network topology hiding may include receiving an SBI request or response message from an NF and replacing a real identifier in the SBI request or response message with a pseudo-identifier for the NF. Performing network topology recovery may include receiving an SBI request or response message including a pseudo-identifier for an NF and replacing the pseudo-identifier with a real identifier for the NF. Network topology manager 504 may also perform the tasks of replicating network topology information to mate SEPPs and checking to see if updated network topology information is available at mate SEPPs before using the updated network topology information for network topology hiding.

SEPP 126C may also include a routing manager 506 for routing received messages based on information in the messages and in network topology database 200B. For example, routing manager 506 may receive an SBI request message inbound to the site or region protected by SEPP 126C after network topology manager 504 has performed network topology recovery for the message and may route or forward the message to the destination producer NF. For SBI messages outbound from the region or site protected by SEPP 126C, routing manager 506 may receive the messages and route or forward the messages to the SEPP associated with the PLMN in which the target NF is located. Network topology manager 504 and routing manager 506 may each be implemented using computer executable instructions stored in memory 502 and executed by processor 500.

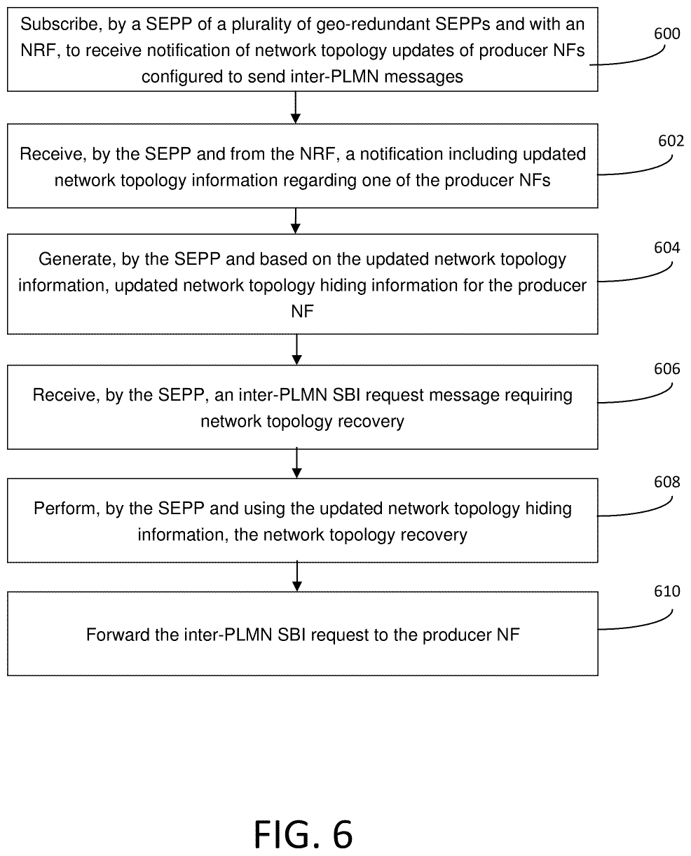

FIG. 6 is a flow chart illustrating an exemplary process for increasing resilience of network topology hiding across geo-redundant SEPPs. Referring to FIG. 6, in step 600, the process includes subscribing, by a SEPP of a plurality of geo-redundant SEPPs and with an NRF, to receive notification of network topology updates of producer NFs configured to send inter-PLMN messages. For example, a SEPP, such as SEPP 126C, of a plurality of geo-redundant SEPPs may send an NF status subscribe message to an NRF to receive notification of network topology updates regarding any NF in the network, region or site protected by the SEPP that is capable of sending inter-PLMN SBI request or response messages. The reason for subscribing to receive notifications of network topology updates for such NFs is that inter-PLMN messages are the type of messages for which NF topology hiding will be needed to hide the real identities of the NFs in the home network.

In step 602, the process further includes receiving, by the SEPP and from the NRF, a notification including updated network topology information regarding one of the producer NFs. For example, a subscribing SEPP, such as SEPP 126C, may receive an NF status notify request message from an NRF. The NF status notify request message may include updated network topology information for one or more NFs based on the subscription created in step 600.

In step 604, the process further includes generating, by the SEPP and based on the updated network topology information, updated network topology hiding information for the producer NF. For example, a SEPP, such as SEPP 126C, may generate a pseudo-identifier, such as a pseudo-FQDN, for an NF and store a mapping between the pseudo-identifier and a real identifier, such as a real FQDN, for the NF. The generated identifier is referred to as a pseudo-identifier because it differs from the real FQDN of the NF and thus hides the real identity of the NF from NFs and hackers outside of the network protected by the SEPP.

In step 606, the process further includes receiving, by the SEPP, an inter-PLMN SBI request message requiring network topology recovery. For example, a SEPP, such as SEPP 126C, may receive an inter-PLMN SBI request message with a 3gpp-Sbi-Target-apiRoot header including a pseudo-identifier of an NF for which the SEPP has a mapping to a real identifier. Upon receiving such a message, the SEPP will determine that the message is addressed to an NF in the network, site or region protected by the SEPP based on the presence of the pseudo-identifier.

In step 608, the process further includes performing, by the SEPP and using the updated network topology hiding information, the network topology recovery. For example, a SEPP, such as SEPP 126C, may replace the pseudo-identifier in the 3gpp-Sbi-Target-apiRoot header with the real identifier for the NF, which may be the real FQDN of the NF.

In step 610, the process further includes forwarding the inter-PLMN SBI request message to the producer NF. For example, after performing the network topology recovery, a SEPP, such as SEPP 126C, will forward the SBI request to the target NF.

It should be noted that prior to using updated network topology information for network topology hiding or recovery, the SEPP that receives an NF topology update from the NRF may verify that the updated network topology information and corresponding network topology hiding information are available at all of its mate SEPPs in a geo-redundant set of SEPPs.

Exemplary advantages of the subject matter described herein include enhanced resilience of network topology hiding and network topology recovery against site failures. The solution described herein may have a low operational/implementation cost as network topology information is dynamically read from the NRF using the NF status subscribe and NF status notify service operations. The solution described herein can be implemented at a SEPP functioning as a P-SEPP, a C-SEPP or both.

The disclosure of each of the following references is hereby incorporated herein by reference in its entirety.

### REFERENCES

1. 3^{rd} Generation Partnership Project; Technical Specification Group Core Network and Terminals; 5G System; Network Function Repository Services; Stage 3 (Release 18) 3GPP TS 29.510 V18.7.0 (2024 June)
2. 3^{rd} Generation Partnership Project; Technical Specification Group Services and System Aspects; Security architecture and procedures for the 5G System (5GS); (Release 18) 3GPP TS 33.501 V18.5.0 (2024 March)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for increasing resilience of network topology hiding across geo-redundant security edge protection proxies (SEPPs), the method comprising:
subscribing, by a SEPP of a plurality of geo-redundant SEPPs and with a network function (NF) repository function (NRF), to receive notification of network topology updates of producer NFs configured to send inter-public land mobile network (PLMN) messages;
receiving, by the SEPP and from the NRF, a notification including updated network topology information regarding one of the producer NFs;
generating, by the SEPP and based on the updated network topology information, updated network topology hiding information for the producer NF;
receiving, by the SEPP, an inter-PLMN service-based-interface (SBI) request message requiring network topology recovery;
performing, by the SEPP and using the updated network topology hiding information, the network topology recovery; and
forwarding the inter-PLMN SBI request message to the producer NF.

2. The method of claim 1 wherein subscribing with the NRF comprises sending an NF status subscribe message to the NRF.

3. The method of claim 1 wherein subscribing with the NRF comprises subscribing with a central NRF of a plurality of NRFs.

4. The method of claim 1 wherein receiving the notification includes receiving an NF status notify request message.

5. The method of claim 1 wherein receiving the notification includes receiving an updated fully qualified domain name (FQDN) of the producer NF that is different from a previous FQDN of the producer NF that was registered with the NRF.

6. The method of claim 5 wherein generating the updated network topology hiding information includes generating an updated pseudo-FQDN for the producer NF that is different from a pseudo-FQDN mapped to the previous FQDN of the producer NF that was registered with the NRF and storing a mapping between the updated pseudo-FQDN and the updated FQDN.

7. The method of claim 6 wherein receiving the inter-PLMN SBI request message requiring network topology recovery includes receiving an inter-PLMN SBI request message addressed to the updated pseudo-FQDN of the producer NF.

8. The method of claim 7 wherein performing the network topology recovery includes accessing the stored mapping between the updated pseudo-FQDN and the updated FQDN and replacing the updated pseudo-FQDN with the updated FQDN.

9. The method of claim 8 wherein replacing the updated pseudo-FQDN with the updated FQDN includes replacing the updated pseudo-FQDN in a 3gpp-Sbi-Target-apiRoot header of the inter-PLMN SBI request message.

10. The method of claim 1 comprising confirming, by the SEPP and prior to performing network topology hiding using the updated network topology information, that the updated network topology information is available at the geo-redundant SEPPs.

11. A system for increasing resilience of network topology hiding across geo-redundant security edge protection proxies (SEPPs), the system comprising:
a SEPP including at least one processor and a memory;
a network topology manager implemented by the at least one processor for subscribing with a network function (NF) repository function (NRF), to receive notification of network topology updates of producer NFs configured to send inter-public land mobile network (PLMN) messages, receiving, from the NRF, a notification including updated network topology information regarding one of the producer NFs, generating, based on the updated network topology information, updated network topology hiding information for the producer NF, receiving an inter-PLMN service-based-interface (SBI) request message requiring network topology recovery, performing, using the updated network topology hiding information, the network topology recovery; and
a routing manager implemented by the at least one processor for forwarding the inter-PLMN SBI request message to the producer NF.

12. The system of claim 11 wherein the network topology manager is configured to subscribe with the NRF by sending an NF status subscribe message to the NRF.

13. The system of claim 11 wherein the NRF comprises a central NRF of a plurality of NRFs.

14. The system of claim 11 wherein the notification comprises an NF status notify request message.

15. The system of claim 11 wherein the notification includes an updated fully qualified domain name (FQDN) of the producer NF that is different from a previous FQDN of the producer NF that was registered with the NRF.

16. The system of claim 15 wherein the network topology manager is configured to generate the updated network topology hiding information by generating an updated pseudo-FQDN for the producer NF that is different from a pseudo-FQDN mapped to the previous FQDN of the producer NF that was registered with the NRF and wherein the network topology manager is configured to store a mapping between the updated pseudo-FQDN and the updated FQDN.

17. The system of claim 16 wherein the inter-PLMN SBI request message requiring network topology recovery includes an inter-PLMN SBI request message addressed to the updated pseudo-FQDN of the producer NF.

18. The system of claim 17 wherein the network topology manager is configured to perform the network topology recovery by accessing the stored mapping between the updated pseudo-FQDN and the updated FQDN and replacing the updated pseudo-FQDN with the updated FQDN in a 3gpp-Sbi-Target-apiRoot header of the inter-PLMN SBI request message.

19. The system of claim 11 wherein the network topology manager is configured to confirm, prior to performing network topology hiding using the updated network topology information, that the updated network topology information is available at the geo-redundant SEPPs.

20. A non-transitory computer readable medium having stored thereon executable instructions that when executed by a processor of a computer control the computer to perform steps comprising:
subscribing, by a security edge protection proxy (SEPP) of a plurality of geo-redundant SEPPs and with a network function (NF) repository function (NRF), to receive notification of network topology updates of producer NFs configured to send inter-public land mobile network (PLMN) messages;
receiving, by the SEPP and from the NRF, a notification including updated network topology information regarding one of the producer NFs;
generating, by the SEPP and based on the updated network topology information, updated network topology hiding information for the producer NF;
receiving, by the SEPP, an inter-PLMN service-based-interface (SBI) request message requiring network topology recovery;
performing, by the SEPP and using the updated network topology hiding information, the network topology recovery; and
forwarding the inter-PLMN SBI request message to the producer NF.
